(19) United States
(12) Patent Application Publication
(10) Pub. No.: US 2009/0066895 A1
(43) Pub. Date: Mar. 12, 2009

(54) Transflective Liquid Crystal Display Panel

(75) Inventors: Chun-Yi Kuo, Tainan (TW); Yung-Shun Yang, Tainan (TW); Chang-Hao Yang, Tainan (TW); Cheng-Jen Chu, Tainan (TW); Chao-Lien Lin, Tainan (TW)

Correspondence Address: TROP, PRUNER & HU, P.C., 1616 S. VOSS ROAD, SUITE 750, HOUSTON, TX, 77057-2631, US

(73) Assignee: Chi Mei Optoelectronics Corp., Tainan (TW)

(21) Appl. No.: 12/205,237

(22) Filed: Sep. 5, 2008

(30) Foreign Application Priority Data
Sep. 7, 2007 (TW) 96133480
Jan. 30, 2008 (TW) 97103480

(51) Int. Cl. G02F 1/1335; G02F 1/1343

(52) U.S. Cl. 349/114; 349/141

(57) ABSTRACT

A transflective liquid crystal display (LCD) panel including an active device array substrate having a plurality of pixel units, an opposite substrate having a plurality of cell-gap adjusting layers and a liquid crystal layer is provided. Each of the pixel units includes a transparent pixel electrode and a reflective pixel electrode. Each of the reflective pixel electrodes has at least one first slit at a boundary between a transmissive area and a reflective area, and the first slit is extended along the boundary. The cell-gap adjusting layers correspond to the reflective pixel electrodes, respectively. Edges of the cell-gap adjusting layers located near the boundary between the transmissive area and the reflective area are within the corresponding reflective pixel electrodes.

### CROSS-REFERENCE TO RELATED APPLICATION

This application claims priority under 35 U.S.C. §119 to Taiwan Application No. 96133480, filed Sep. 7, 2007, and Taiwan Application No. 97103480, filed Jan. 30, 2008, both of which are hereby incorporated by reference.

### TECHNICAL FIELD

The present invention relates to a transflective liquid crystal display (LCD) panel.

### BACKGROUND

Generally, modern display devices, such as liquid crystal display (LCD) devices, are relatively light and slim, provide relatively high luminance, consume a relatively low amount of power, and provide relatively high quality, full-color images. A display device used with a portable electronic device faces the challenge of being used in environments of varying light conditions (e.g., indoors in a home or office environment, and outside in a sunny and bright environment). In an environment that is relatively bright (such as outside on a sunny day), it is desired that the display device maintain the ability to provide high quality images. To address this issue, transflective LCD devices have been developed in an attempt to maintain desirable display quality when the LCD devices are used in varying light conditions.

In a transflective LCD device, each of the pixel electrodes of an LCD panel includes a reflective conductive thin film and a transparent conductive thin film. The reflective conductive thin film of each pixel provides a reflective mode of operation, in which external ambient light is reflected by the reflective thin film. In an environment with relatively bright ambient light, the reflective mode of operation provides a relatively good display image quality. The transparent conductive thin film enables light from a backlight module in the LCD device to pass through the transparent thin film to provide a transmissive mode of operation. In a relatively low ambient light environment, the transmissive mode of operation enables the LCD device to provide good display image quality. It is noted that the LCD device normally operates simultaneously in both the reflective LCD mode and transmissive LCD mode.

An issue associated with conventional transflective LCD devices is that the arrangement of liquid crystal molecules in the pixels around a boundary between the transmissive area and the reflective area of a pixel may lead to leakage of light.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view of a portion of a transflective LCD (liquid crystal display) device according to a first embodiment of the present invention.

FIG. 2 is a schematic diagram illustrating a transflective LCD panel used in the LCD device of FIG. 1.

FIG. 3 is a top view of a pixel unit in the transflective LCD panel of FIG. 2.

FIG. 4 is a cross-sectional view along a section line I-I″ of FIG. 3.

FIGS. 5A and FIG. 5B are top views of a pixel unit according to another embodiment of the present invention.

FIG. 6 is a top view of a pixel unit according to a second embodiment of the present invention.

FIG. 7 is a top view of a pixel unit according to a third embodiment of the present invention.

FIG. 8 is a schematic diagram illustrating a transfiective LCD panel according to a fourth embodiment of the present invention.

FIG. 9 is a top view of a pixel unit of FIG. 8.

FIG. 10 is a cross-sectional view along a section line II-II′ of FIG. 9.

FIGS. 11-21 are top views of pixel units according to a sixth embodiment to a sixteenth embodiment of the present invention.

### DETAILED DESCRIPTION

### First Embodiment

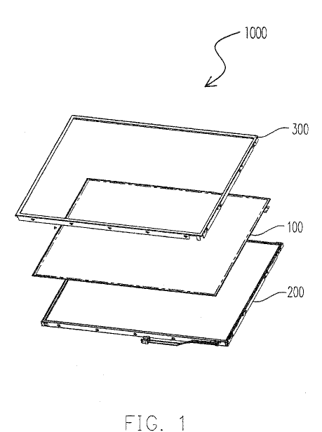

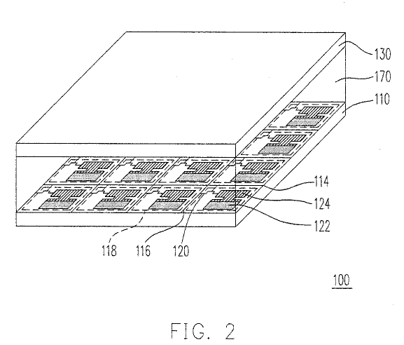

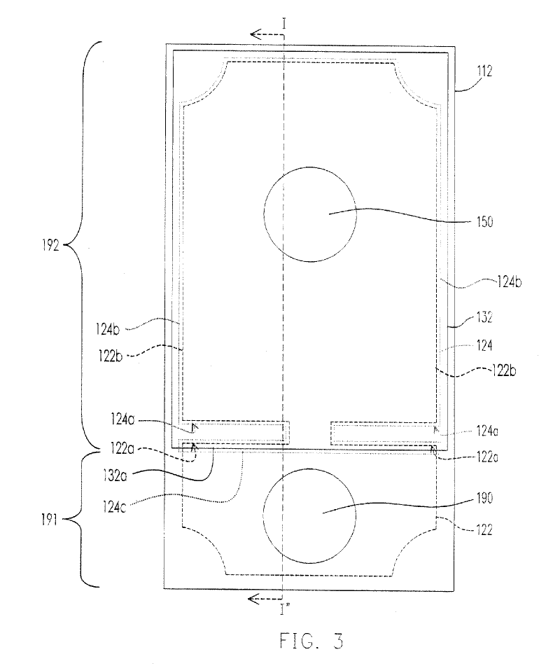

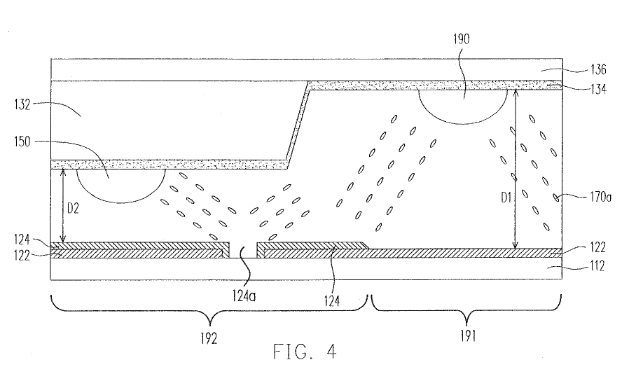

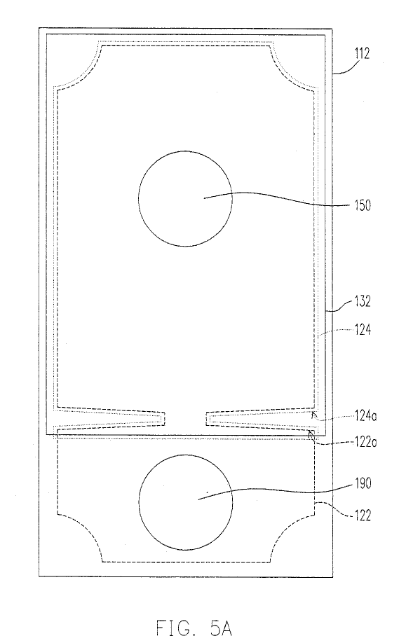

FIG. 1 is a schematic diagram illustrating a transfiective liquid crystal display (LCD) according to a first embodiment of the present invention. FIG. 2 is a schematic diagram illustrating a transflective LCD panel used in the LCD device of FIG. 1. FIG. 3 is a top view of a pixel unit in the LCD panel of FIG. 2, and FIG. 4 is a cross-sectional view along a section line I-I″ of FIG. 3.

Referring to FIGS. 1-4, a transflective LCD device 1000 includes a transflective LCD panel 100, a backlight module 200 and a front frame 300. The transfiective LCD panel 100 includes an active device array substrate 110, an opposite substrate 130, a plurality of first alignment structures 150, a plurality of second alignment structures 190, and a liquid crystal layer 170. The active device array substrate 110 includes a first substrate 112, a plurality of scan lines 114, a plurality of data lines 116, and an array of pixel units 118 provided at the intersections of the scan lines and data lines 116. In the active device array substrate 110, the scan lines 114, data lines 116 and pixel units 118 are disposed on the first substrate 112, and the pixel units 118 are electrically connected to the scan lines 114 and the data lines 116. The material of the first substrate 112 is for example, glass, plastic or other materials, and materials of the scan lines 114 and the data lines 116 are for example, aluminum, chromium, tantalum or other metal materials. In the present embodiment, the first alignment structures 150 and the second alignment structures 190 are alignment protrusions (although alignment slits can be used in other embodiments).

Each pixel unit 118 includes an active device 120, a transparent pixel electrode 122 and a reflective pixel electrode 124. The active device 120 is electrically connected to the scan line 114 and the data line 116. The active device 120 is driven by the scan line 114 and the data line 116, with the scan line 114 used to activate/deactivate the active device 120, and the data line 116 providing a signal to be transmitted through the active device 120 when the active device 120 is activated. The active device 120 can be a thin film transistor, a bipolar transistor or other active devices having three terminals. A signal in the data line 116 passes through an activated active device 120 to both the transparent pixel electrode 122 and reflective pixel electrode 124.

In the present embodiment, the transparent pixel electrode 122 and the reflective pixel electrode 124 are electrically connected to the active device 120, and the reflective pixel electrode 124 is located over (or alternatively, below) a portion of the transparent pixel electrode 122 (as best seen in FIG. 4). In general, the reflective pixel electrode 124 overlaps a portion of the transparent pixel electrode 122. However, in another embodiment, the reflective pixel electrode 124 does not overlap the transparent pixel electrode 122. An example material of the transparent pixel electrode 122 can be indium tin oxide (ITO), indium zinc oxide (IZO) or other transparent metal oxides. In addition, an example material of the reflective pixel electrode 124 includes aluminum or other reflective metal materials.

In the first embodiment, the reflective pixel electrode 124 has two first slits 124a located adjacent to the transparent pixel electrode 122. Each of the first slits 124a extends from a respective outer boundary 124b (FIG. 3) of the reflective pixel electrode 124 toward a center region of the reflective pixel electrode 124. The first slits 124a are located near a transmissive area (indicated by reference numeral 191 in FIGS. 3 and 4) defined by a region of the pixel unit that includes the transparent pixel electrode 122 but not the reflective pixel electrode 124. A reflective area of the pixel unit is an area 192 (FIGS. 3, 4) that includes the reflective pixel electrode 124.

In the depicted embodiment, since the reflective pixel electrode 124 is disposed over a portion of the transparent pixel electrode 122, the transparent pixel electrode 122 also has two second slits 122a respectively aligned with and located below the two first slits 124a. Moreover, in the reflective area 192, edges of the two second slits 122a are respectively located within the edges of the reflective pixel electrode 124. In fact, in the reflective area 192, as seen in the top view of FIG. 3, all edges or boundaries of the transparent pixel electrode 122 are within the edges of the reflective pixel electrode 124 (in other words, the area of the transparent pixel electrode 122 is confined within the area of the reflective pixel electrode 124). Each of the second slits 122a extends from a respective outer boundary 122b (FIG. 3) of the transparent pixel electrode 122 to a center region of the transparent pixel electrode 122. Stated differently, one end of each first slit 124a and second slit 122a is provided at the outer boundary (124b or 122b) of the respective reflective pixel electrode 124 and the transparent pixel electrode 122, and the other end of each first slit 124a and second slit 122a is located within the respective reflective pixel electrode 124 and the transparent pixel electrode 122. The shape of each of the slits 124a and 122a is generally rectangular, such that the widths of the two ends of each slit 124a are approximately the same, and the widths of the two ends of each slit 122a are approximately the same.

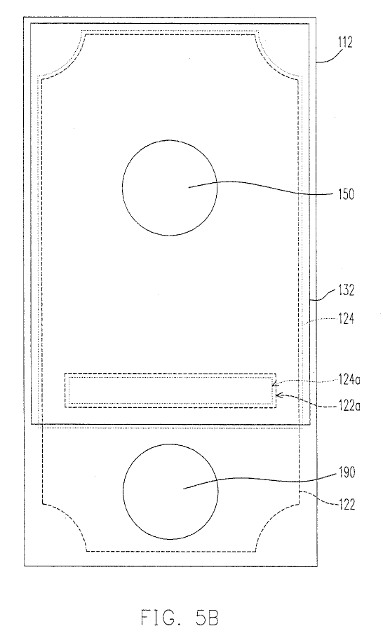

In a variation of the first embodiment, shapes of the first slit 124a and the second slit 122a can alternatively be trapezoids (as shown in FIG. 5A). In other words, the width of one end of each slit (124a or 122a) is greater than that of the other end of the slit. In yet another variation of the first embodiment, the ends of slits (124a or 122a) do not extend from the outer boundaries of the reflective pixel electrode 124 or the transparent pixel electrode 122 (as shown in FIG. 5B). Instead, in FIG. 5B, one slit 124a is provided in the reflective pixel electrode 124, and another slit 122a is provided in the transmissive pixel electrode 122.

The opposite substrate 130 disposed above the active device array substrate 1 10 includes a second substrate 136 and a common electrode layer 134. Note that, in one implementation, the opposite substrate 130 can be a color filter substrate. One side of the opposite substrate 130 facing the active device array substrate 110 has a plurality of cell-gap adjusting layers 132. Each cell-gap adjusting layer 132 is located in a region of the pixel unit corresponding to the reflective pixel electrode 124. As shown in FIG. 4, the cell-gap adjusting layer 132 is located above the reflective pixel electrode 124. In the first embodiment, a vertical distance D1 (FIG. 4) between the transparent pixel electrode 122 and the common electrode layer 134 of the pixel unit 118 is greater than a distance D2 between the reflective pixel electrode 124 and the corresponding common electrode layer 134 (the portion disposed on the cell-gap adjusting layer 132) of the pixel unit 118. In one implementation, D1 is at least double D2. An example material of the cell-gap adjusting layer 132 can be a dielectric material or a photoresistive material.

The cell gap adjusting layer 132 in each pixel unit is provided in the reflective area 192 to reduce the distance D2 between the common electrode layer 134 and the reflective pixel electrode 124.

Light from the backlight module passes through the liquid crystal layer 170 in the transmissive area 191 in one direction—as a result, the distance traversed through the liquid crystal layer in the transmissive area 191 is at least D1 (depending upon the angle at which the light passes through the liquid crystal layer). Note, however, that light in the reflective area 192 traverses through the liquid crystal layer 170 twice. In the view of FIG. 4, external light passes from above the assembly of FIG. 4 through the liquid crystal layer 170 to the reflective pixel electrode 124. The light is then reflected by the reflective pixel electrode 124 back through the liquid crystal layer 170. Since the light in the reflective area 192 has to traverse the liquid crystal layer twice, the cell-gap adjusting layer 132 is provided to reduce the distance D2 (and thus the thickness of the liquid crystal layer) in the reflective area 192 between the common electrode layer 134 and the reflective pixel electrode 124 to about half D1, in some implementations. This allows the light to have about the same retardation in the transmissive area and reflective area.

In the first embodiment, at or near the boundary between the transmissive area 191 and reflective area 192, an end boundary 132a of the cell-gap adjusting layer 132 is located within the corresponding end boundary 124c of the reflective pixel electrode 124. Moreover, the end boundary 132a of the cell-gap adjusting layer 132 is located between the first slits 124a and the end boundary 124c of the reflective pixel electrode 124. A distance between the end boundary 124c of the reflective pixel electrode 124 and the corresponding end boundary 132a of the cell-gap adjusting layer 132 can be 3-5 micrometers, in one example. In other words, the reflective pixel electrode 124 covers the end boundary 132a of the cell-gap adjusting layer 132 at or near the boundary between the transmissive area 191 and reflective area 192. Since the arrangement of liquid crystal molecules 170a at the end boundary 132a of the cell-gap adjusting layer 132 is rather disorderly (in other words, the angles of liquid crystal molecules at such boundary are different from the angles of liquid crystal molecules elsewhere in the pixel unit under the same applied voltage), the reflective pixel electrode 124 can shield light leakage caused by the cell-gap adjusting layer 132. Moreover, a fringe field effect generated due to an edge step of the reflective pixel electrode 124 can also strengthen the arrangement of the liquid crystal molecules 170a and align it towards the second alignment structure 190, so as to reduce light leakage.

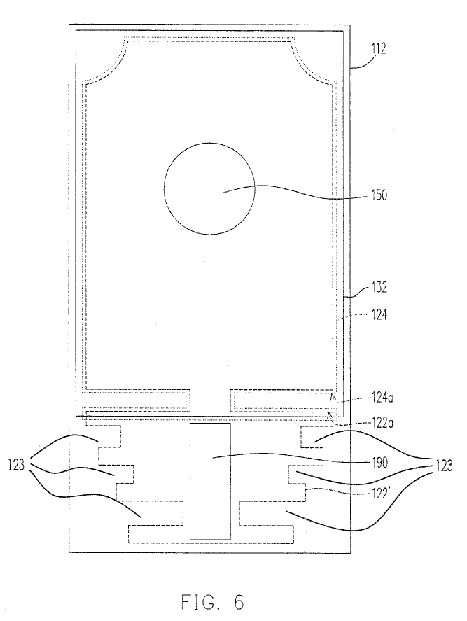

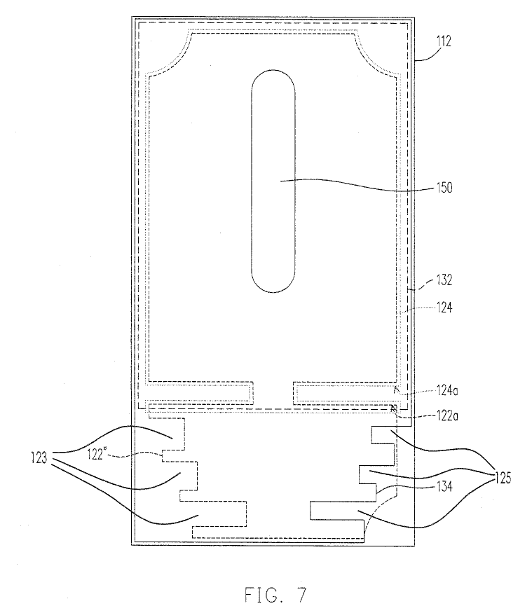

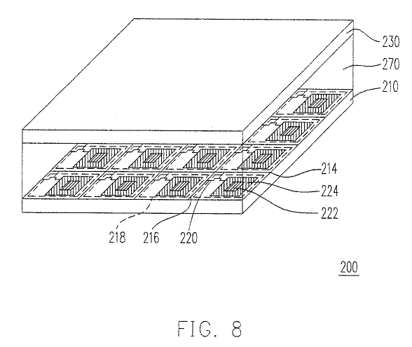

The first alignment structures 150 are disposed in the region of the pixel units corresponding to the cell-gap adjusting layers 132 of the opposite substrate 130, and respectively correspond to the reflective pixel electrodes 124 of the pixel units 118. The liquid crystal layer 170 is disposed between the active device array substrate 110 and the opposite substrate 130. In the first embodiment of the present invention, the transfiective LCD panel 100 further includes second alignment structures 190 which are disposed on the opposite substrate 130, and are located in regions of the pixel units corresponding to the transparent pixel electrodes 122 of the pixel units 118. Shapes of the first alignment structures 150 and/or the second alignment structures 190 can be generally circular (FIG. 3), rectangular (FIG. 6), oval column shaped (FIG. 7), and so forth.

The backlight module 200 can be a direct type backlight module or an edge light backlight module. Light source utilized in the backlight module 200 can be a cold cathode fluorescence lamp (CCFL), a light emitting diode (LED) or other suitable light sources. Moreover, material of the front frame 300 is for example iron, aluminum, or other materials.

### Second Embodiment

FIG. 6 is a top view of a pixel unit according to a second embodiment of the present invention. Referring to FIG. 6, a difference between the second embodiment and the first embodiment is that the boundaries of portions of the transparent pixel electrode 122′ in the transmissive area include indentations 123 to provide comb-shaped edges. By patterning the transparent pixel electrode 122′ with indentations 123, the fringe field effect can be enhanced in the transmissive area (area that includes the transparent pixel electrode but not the reflective pixel electrode), so that the multi-domain vertical aligned liquid crystal molecules 170a can be more stable, and reaction time thereof can be shortened. Moreover, the first slits 124a and the first alignment structures 150 (alignment protrusions) of the first embodiment can also be applied to the second embodiment.

### Third Embodiment

FIG. 7 is a top view of a pixel unit according to a third embodiment of the present invention. Referring to FIG. 7, a difference between the third embodiment and the first embodiment is that the boundaries of portions of the transparent pixel electrode 122″ include indentations 123, and the boundaries of portions of the common electrode layer 134 of the opposite substrate 130 also has comb-shaped openings 125. The indentations 123 of the transparent pixel electrode 122″ are arranged symmetrically to the comb-shaped openings 125 of the common electrode layer 134. By patterning the transparent pixel electrode 122″ and the common electrode layer 134 with symmetric indentations and comb-shaped openings for aligning liquid crystal molecules, deposition of the second alignment structures 190 (alignment protrusions) in the transmissive area is unnecessary. Therefore, the transmissive area corresponding to the transparent pixel electrode 122″ in the pixel Unit 118 almost has no dark stripes, so that transmissivity of the transmissive area is improved. Moreover, the first slits 124a and the first alignment structures 150 (alignment protrusions) of the first embodiment can also be applied to the third embodiment.

### Fourth Embodiment

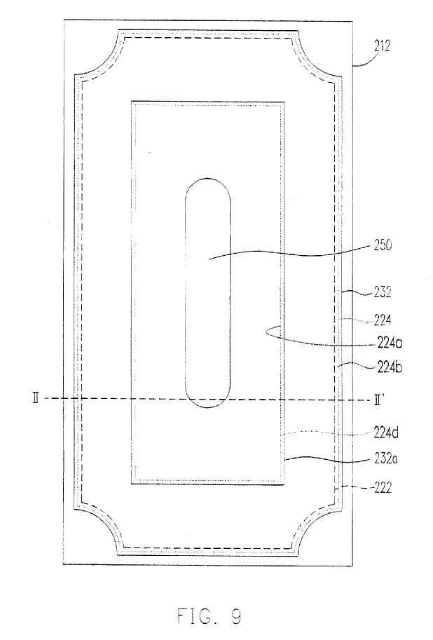

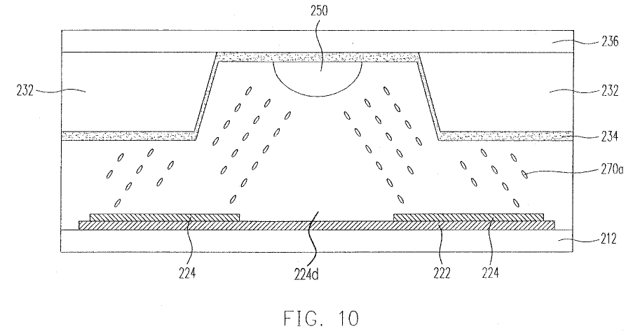

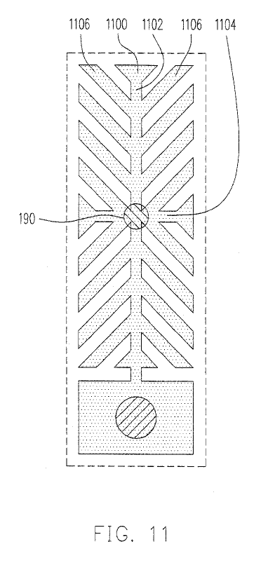

FIG. 8 is a schematic diagram illustrating a transflective LCD panel according to the fourth embodiment of the present invention, FIG. 9 is a top view of a pixel unit in the LCD panel of FIG. 8, and FIG. 10 is a cross-sectional view along a section line II-II′ of FIG. 9.

The transflective LCD panel 200 includes an active device array substrate 210, an opposite substrate 230, a plurality of alignment structures 250, and a liquid crystal layer 270. The active device array substrate 210 includes a first substrate 212, a plurality of scan lines 214, a plurality of data lines 216 and a plurality of pixel units 218. In the active device array substrate 210, the scan lines 214, data lines 216 and pixel units 218 are disposed on the first substrate 212, and the pixel units 218 are electrically connected to the scan lines 214 and the data lines 216. Example materials of the substrate 210 include for example, glass, plastic or other materials, and example materials of the scan lines 214 and the data lines 216 are for example, chromium, tantalum or other metal materials.

The pixel unit 218 includes an active device 220, a transparent pixel electrode 222 and a reflective pixel electrode 224. The active device 220 is electrically connected to the scan line 214 and the data line 216. The active device 220 is driven by the scan line 214 and the data line 216. The active device 220 can be a thin film transistor, a bipolar transistor or other active devices having three terminals.

The transparent pixel electrode 222 and the reflective pixel electrode 224 are electrically connected to the active device 220, and the reflective pixel electrode 224 is located over a portion of the transparent pixel electrode 222 (as shown in FIG. 10). In general, the reflective pixel electrode 224 overlaps a portion of the transparent pixel electrode 222. However, it should be noted that in another embodiment of the present invention, the reflective pixel electrode 224 does not overlap the transparent pixel electrode 222.

In this embodiment, the reflective pixel electrode 224 has a central opening (slit) 224d for exposing the transparent pixel electrode 222. In other words, in each of the pixel units 218, the central opening 224d is the transmissive area corresponding to the transparent pixel electrode 222, and the peripheral area of the reflective pixel electrode 224 around the central opening 224d constitutes the reflective area corresponding to the reflective pixel electrode 224. Example materials of the transparent pixel electrode 222 can be TO, IZO or other transparent metal oxides. In addition, example materials of the reflective pixel electrode 224 include aluminum or other reflective metal materials.

The opposite substrate 230 is disposed above the active device array substrate 210, and includes a second substrate 236 and a common electrode layer 234. One side of the opposite substrate 230 facing the active device array substrate 210 has a plurality of cell-gap adjusting layers 232 having central openings 232a, which are located above the reflective pixel electrode 224. The boundary of the central opening 232a of each cell-gap adjusting layer 232 is located within the boundaries of the corresponding reflective pixel electrode 224 such that the boundary of the central opening 232a is covered by the reflective pixel electrode 224. In other words, the boundary of the central opening 232a of each cell-gap adjusting layer 232 is located between an inner edge 224a and an outer edge 224b of the reflective pixel electrode. The area of the central opening 232a of the cell-gap adjusting layer 232 is larger than an area of the central opening 224d of the reflective pixel electrode 224. As a result, the light leakage caused by the cell-gap adjusting layer 232 can be shielded by the reflective pixel electrode 224. In addition, the liquid crystal molecules 270a can be inclined inside to form the multi-domain vertical alignment. Example materials of the cell-gap adjusting layer 232 can be a dielectric material or photoresistive material. In this embodiment, an alignment structure 250 located corresponding to a center of the transparent pixel electrode 222 is further disposed on the opposite substrate 230, so that stability of domains of the multi-domain vertical alignment can be improved. The alignment structure 250 is for example, an alignment protrusion with a shape of a long bar, a hemisphere, or an oval column.

### Fifth Embodiment

A difference between the fifth embodiment and the first to fourth embodiments is that in the fifth embodiment, the alignment structure is a slit (instead of a protrusion) on the common electrode layer 134, which has a similar size as that of the alignment structures of the aforementioned embodiments. The alignment slits are used to reduce dark stripes of the pixels, and to increase display luminance.

### Sixth Embodiment

FIG. 11 is a top view of a pixel unit according to the sixth embodiment of the present invention. Referring to FIG. 11, a difference between the sixth embodiment and the aforementioned embodiments lies in a pattern of a transparent pixel electrode 1100. To be specific, each of the transparent pixel electrodes 1100 has a first segment (vertical segment in the view of FIG. 11) 1102, a second segment 1104 (horizontal segment in the view of FIG. 11) and a plurality of slanted branches 1106 within the transmissive area of the pixel unit that extend from the first segment 1102 or second segment 1104. The first segment 1102 is substantially perpendicular to the second segment 1104, so that the transmissive area is divided into four quadrants. The second segment 1104 can be taken as a benchmark for calculating angles of the slanted branches 1106, and the angles of the plurality of branches 1106 within the same quadrant are all the same. The angles of the branches 1106 in each of the four quadrants are respectively 45°, 135°, 225° and 315°. Accordingly, the liquid crystal molecules can be effectively pushed towards an intersection of the first segment 1102 and the second segment 1104, and are symmetrically arranged around the intersection, so that differences of the transmissivities corresponding to different viewing angles can be reduced to achieve a wide viewing angle effect. Moreover, the second alignment structure (a hemispheric protrusion, for example) 190 of FIG. 4 can be applied and disposed at a location corresponding to the intersection of the first segment 1102 and the second segment 1104 to further achieve a better wide viewing angle effect.

### Seventh Embodiment

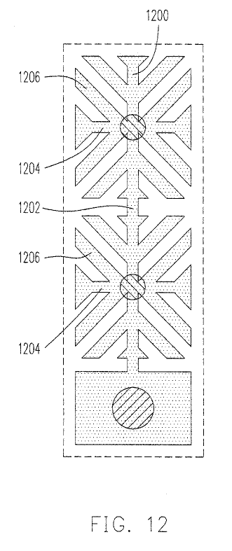

FIG. 12 is a top view of a pixel unit according to the seventh embodiment of the present invention. Referring to FIG. 12, a difference between the seventh embodiment and the aforementioned embodiments lies in a pattern of a transparent pixel electrode 1200. To be specific, each of the transparent pixel electrodes 1200 has a first segment 1202, a plurality of second segments 1204 and a plurality of slanted branches 1206 within the transmissive area. Each of the second segments 1204 is substantially perpendicular to the first segment 1202, and different portions of the transmissive area are divided into four quadrants by each combination of a second segment 1204 and the first segment 1202. Each second segment 1204 can be taken as a benchmark for calculating the angles of the slanted branches, and the angles of the plurality of branches 1206 within the same quadrant are all the same. The angles of the branches 1206 in the four quadrants are sequentially 45°, 135°, 225° and 315°. Generally, according to this embodiment, a single transmissive area is divided into a plurality of regions, and each of the regions has four kinds of branches 1206 having different azimuths. By such means, a better wide viewing angle effect can be achieved.

### Eighth Embodiment

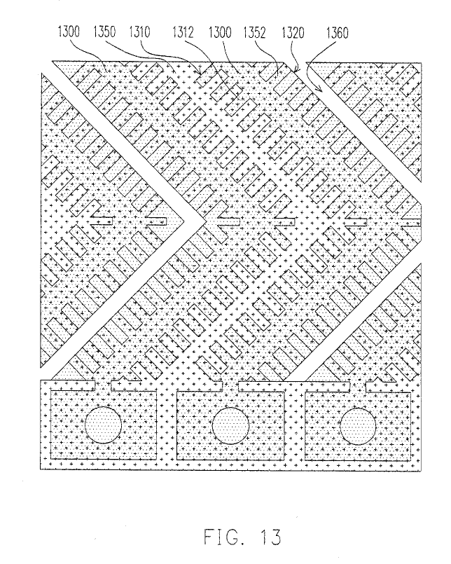

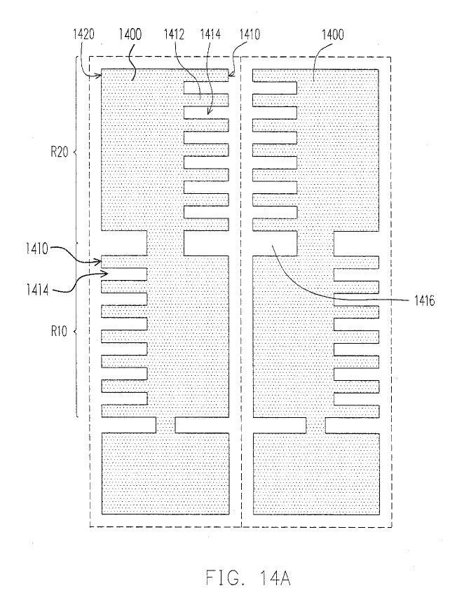

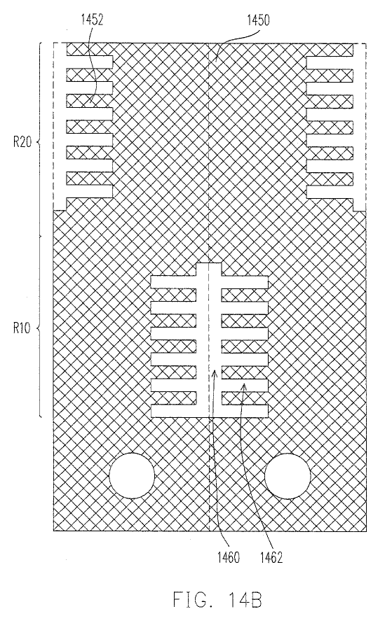

FIG. 13 is a top view of a pixel unit according to an eighth embodiment of the present invention. Referring to FIG. 13, a difference between the eighth embodiment and the aforementioned embodiments lies in patterns of a transparent pixel electrode 1300 and a common electrode layer 1350. To be specific, each of the transparent pixel electrodes 1300 in the transmissive area is substantially arrow-shaped, and the transparent pixel electrode 1300 has a comb-shaped edge 1310 (provided by indentations 1312) and a smooth edge 1320 at two different sides of the transmissive area. Meanwhile, the smooth edges 1320 of the transparent pixel electrodes 1300 are disposed oppositely one another, as are the comb-shaped edges 1310 of the transparent pixel electrodes 1300. Moreover, each of the second alignment structures is provided by an opening 1360 of the common electrode layer 1350. Indentations 1352 of the common electrode layer 1350 adjacent the openings 1360 are interlaced with the indentations 1312 of the comb-shaped edge 1310 of the transparent pixel electrodes 1300. In this manner, the domains of the liquid crystal molecules are arranged to achieve the wide viewing angle effect; in addition, generation of the dark stripe is reduced and the transmissivity thereof is improved.

### Ninth Embodiment

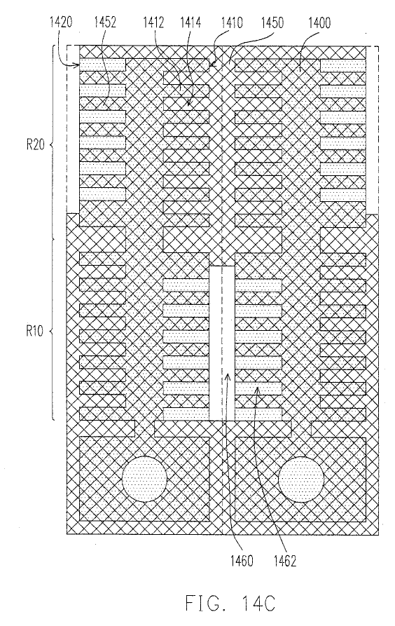

FIGS. 14A-14C are top views of a pixel unit according to a ninth embodiment of the present invention. In FIG. 14A, only a transparent pixel electrode is illustrated, in FIG. 14B, only a common electrode layer is illustrated, and in FIG. 14C, the transparent pixel electrode and the common electrode layer are simultaneously illustrated. Referring to FIG. 14, a difference between the ninth embodiment and the aforementioned embodiments lies in patterns of a transparent pixel electrode 1400 and a common electrode layer 1450. To be specific, each of the transmissive areas is divided into a first area R10 located adjacent the reflective area and a second area R20 away from the reflective area. Each of the transparent pixel electrodes 1400 has a comb-shaped edge 1410 (with indentations 1414 and protrusions 1412 as depicted) and a smooth edge 1420 within the first area R10, and each of the transparent pixel electrodes 1400 has a comb-shaped 1410 and a smooth edge 1420 within the second area R20. The two comb-shaped edges 1410 of each of the transparent pixel electrode 1400 within the first area R10 and the second area R20 are located at different sides of the transparent pixel electrode 1400. In this manner, domains of the liquid crystal molecules in the first area R10 and the second area R20 are different, which can also provide a wide viewing angle effect and improve the transmissivity thereof. In the depicted embodiment, two adjacent transparent pixel electrodes 1400 are symmetric about a boundary line between the adjacent transparent pixel electrodes.

Moreover, the lengths of indentations of the comb-shaped edge 1410 of each of the transparent pixel electrode 1400 are the same. In addition, as shown in FIG. 14B, the second alignment structure on the common electrode layer 1450 is provided by an opening 1460 having indentations 1462—the length of the indentations 1462 of each of the openings 1460 are the same, and the openings 1460 are also symmetric about a line (vertical line in the view of FIG. 14B). Moreover, protrusions 1452 of the common electrode layer 1450 defining the indentations 1462 are interlaced with indentations 1412 of the comb-shaped edge 1410 of the transparent pixel electrode 1400.

The transparent pixel electrode 1400 further has a slit 1416 at a boundary of the first area R10 and the second area R20. A width of the slit 1416 is greater than that of each indentation 1414. The slit 1416 separates the two liquid crystal molecule domains (in regions R10 and R20) to avoid interference of the liquid crystal molecule alignment.

### Tenth Embodiment

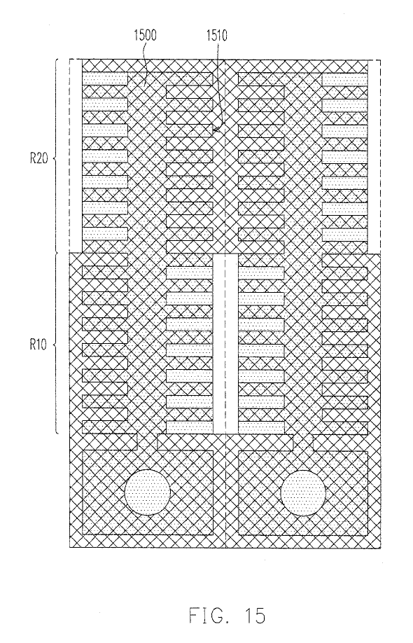

FIG. 15 is a top view of a pixel unit according to a tenth embodiment of the present invention. Referring to FIGS. 14A-14C and FIG. 15, a difference between the tenth embodiment and the ninth embodiment is that a transparent pixel electrode 1500 in FIG. 15 does not include the slit 1416 (shown in FIG. 14A) at the boundary of the first area R10 and the second area R20, so that the dark stripes are reduced and the transmissivity is improved.

### Eleventh Embodiment

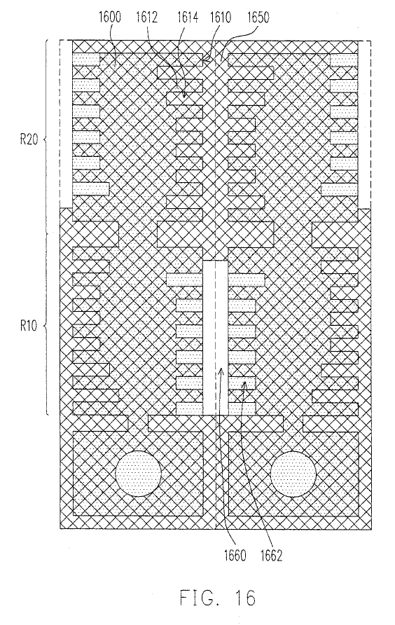

FIG. 16 is a top view of a pixel unit according to an eleventh embodiment of the present invention. Referring to FIG. 16, a difference between the pixel unit of the eleventh embodiment and that of the ninth embodiment is that indentations 1614 among protrusions 1612 of a comb-shaped edge 1610 of each of transparent pixel electrode 1600 have different lengths. In addition, lengths of the indentations 1614 located adjacent centers of the first area R10 and the second area R20 are less than that of the indentations 1614 located at other positions. Moreover, protrusions 1662 of each of openings 1660 of the common electrode layer 1650 have different lengths. In addition, the lengths of the protrusions 1662 located at the boundary of the first area R10 and the second area R20 are greater than that of the dentations 1662 located at other positions.

### Twelfth Embodiment

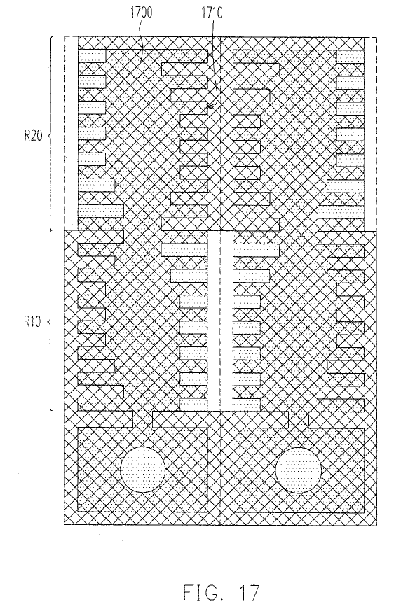

FIG. 17 is a top view of a pixel unit according to a twelfth embodiment of the present invention. Referring to FIG. 16 and FIG. 17, a difference between the eleventh embodiment and the twelfth embodiment is that a transparent pixel electrode 1700 does not the slit at the boundary of the first area R10 and the second area R20, so that the dark stripes are reduced and the transmissivity is improved.

### Thirteenth Embodiment

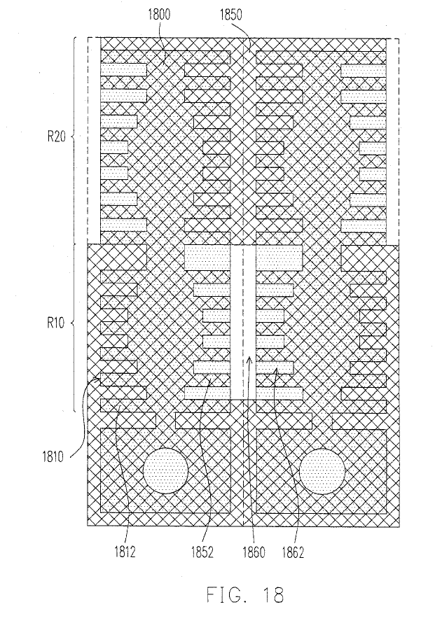

FIG. 18 is a top view of a pixel unit according to a thirteenth embodiment of the present invention. Referring to FIG. 18, a difference between the present embodiment and the thirteenth embodiment is that lengths of protrusions 1862 of each of openings 1860 located adjacent the centers of the first area R10 and the second area R20 are less than that of the protrusions 1862 located at other positions. Moreover, protrusions 1852 of the common electrode layer 1850 beside the openings 1860 are aligned to protrusions 1812 of a comb-shaped edge 1810 of a transparent pixel electrode 1800.

### Fourteenth Embodiment

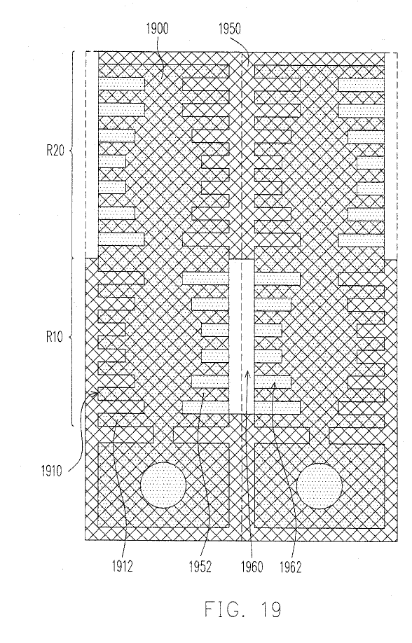

FIG. 19 is a top view of a pixel unit according to a fourteenth embodiment of the present invention. Referring to FIG. 19, a difference between the fourteenth embodiment and the twelfth embodiment is that lengths of protrusions 1962 of each of openings 1960 of a common electrode layer 1950 located adjacent to the centers of the first area R10 and the second area R20 are less than that of the dentations 1962 located at other positions. Moreover, protrusions 1952 of the common electrode layer 1950 beside the dentate openings 1960 are aligned to dentations 1912 of a comb-shaped edge 1910 of a transparent pixel electrode 1900.

### Fifteenth Embodiment

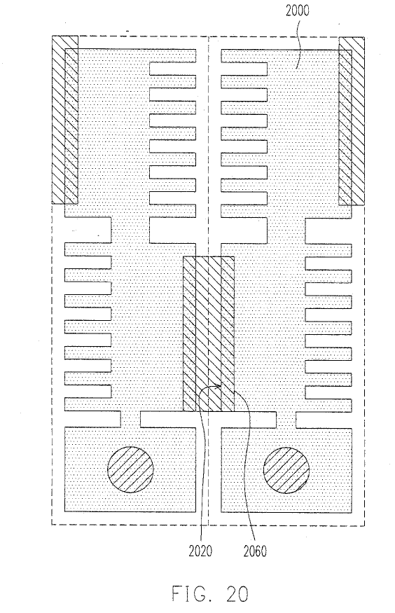

FIG. 20 is a top view of a pixel unit according to a fifteenth embodiment of the present invention. Referring to FIG. 20, a difference between the fifteenth embodiment and a ninth embodiment is that the second alignment structure 2060 is a protrusion having a shape of a long bar or an oval column, and a position thereof corresponds to a smooth edge 2020 of a transparent pixel electrode 2000. In FIG. 20, only the position of the second alignment structure 2060 is illustrated, and the common electrode layer is not illustrated.

### Sixteenth Embodiment

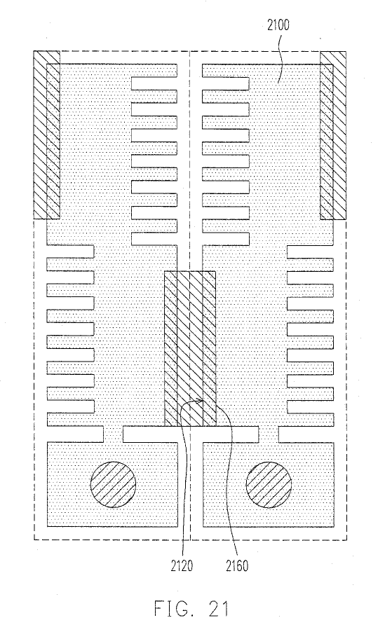

FIG. 21 is a top view of a pixel unit according to a sixteenth embodiment of the present invention. Referring to FIG. 21, a difference between the sixteenth embodiment and the tenth embodiment is that the second alignment structure 2160 is a protrusion having a shape of the long bar or the oval column, and a position thereof corresponds to a smooth edge 2120 of a transparent pixel electrode 2100. In the FIG. 21, only the position of the second alignment structure 2160 is illustrated, and the common electrode layer is not illustrated.

In summary, in the transflective LCD panel according to some embodiments of the present invention, the reflective pixel electrode has at least one slit which can divide alignments of the liquid crystal molecules in the reflective area and the transmissive area, so as to mitigate an arrangement disorder of the liquid crystal molecules at the boundary of the transparent pixel electrode and the reflective pixel electrode. Moreover, the edge of the cell-gap adjusting layer at the boundary of the transparent pixel electrode and the reflective pixel electrode is covered by the reflective pixel electrode, so that light leakage caused by the cell-gap adjusting layer can be shielded, and arrangement direction of the liquid crystal molecules can be pushed towards a same side.

In the transflective LCD panel according to some embodiments of the present invention, the reflective pixel electrode and the cell-gap adjusting layer have a central opening for exposing the transparent pixel electrode. The reflective pixel electrode covers the edge of the cell-gap adjusting layer to shield the light leakage caused by the cell-gap adjusting layer. Moreover, with coordination of the cell-gap adjusting layer and the reflective pixel electrode, the liquid crystal molecules all around can be inclined inside to form the multi-domain vertical alignment. In addition, the alignment structure is applied to the center of the pixel unit, so as to improve the stability of the liquid crystal domains.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transflective liquid crystal display (LCD) panel, comprising:
a first substrate having an array of pixel units, wherein each of the pixel units comprises:
an active device;
a transparent pixel electrode connected to the active device and disposed in a transmissive area of the corresponding pixel unit;
a reflective pixel electrode connected to the active device and disposed in a reflective area of the corresponding pixel unit, wherein the reflective pixel electrode has at least one first slit located adjacent a boundary between the transmissive area and the reflective area; and
an opposite substrate, spaced apart from the first substrate, and comprising:
a second substrate;
a plurality of cell-gap adjusting layers, respectively corresponding to the reflective pixel electrodes of the pixel units, wherein an edge of each cell-gap adjusting layer located near the boundary between the transmissive area and the reflective area in a corresponding pixel unit is covered by a corresponding reflective pixel electrode..

2. The transflective LCD panel as claimed in claim 1, further comprising scan lines and data lines on the first substrate that are connected to respective active devices.

3. The transflective LCD panel as claimed in claim 1, wherein the opposite substrate further comprises:
a common electrode layer, covering the second substrate and the cell-gap adjusting layers;
a plurality of first alignment structures, disposed on the opposite substrate, and respectively corresponding to the reflective area of each of the pixel units; and
a plurality of second alignment structures, disposed on the opposite substrate, and respectively corresponding to the transmissive area of each of the pixel units; and
wherein the transreflective LCD panel further comprises a liquid crystal layer, disposed between the active device array substrate and the opposite substrate.

4. The transflective LCD panel as claimed in claim 1, wherein the first slit is located within the edge of a corresponding cell-gap adjusting layer.

5. The transflective LCD panel as claimed in claim 1, wherein in each of the pixel units, a portion of the transparent pixel electrode is located below the reflective pixel electrode.

6. The transflective LCD panel as claimed in claim 5, wherein in each of the pixel units, the transparent pixel electrode has at least one second slit located below the first slit, and an edge of the first slit is located within the edge of the second slit.

7. The transflective LCD panel as claimed in claim 1, wherein the transparent pixel electrodes have comb-shaped edges.

8. The transflective LCD panel as claimed in claim 7, wherein the common electrode layer has a plurality of comb-shaped openings, and in each of the pixel units, the comb-shaped edges of the transparent pixel electrode are arranged symmetrically to the comb-shaped openings of the common electrode layer.

9. The transflective LCD panel as claimed in claim 1, wherein each of the transparent pixel electrodes has a first segment, wherein a second segment, and a plurality of slanted branches within the transmissive area, the first segment is substantially perpendicular to the second segment to divide the transmissive area into four quadrants, wherein angles of the branches within the same quadrant are all the same while taking the second branch as a benchmark, and the azimuths of the third branches in each of the four quadrants are sequentially 45°, 135°, 225° and 315°.

10. The transflective LCD panel as claimed in claim 9, further comprising second alignment structures that are protrusions located at corresponding intersections of the first segments and the second segments, wherein the second alignment structures are provided in corresponding transmissive areas of the pixel units.

11. The transflective LCD panel as claimed in claim 1, wherein each of the transparent pixel electrodes has a first segment, a plurality of second segments, and a plurality of slanted branches within the transmissive area, wherein each of the second segments is substantially perpendicular to the first segment to divide a portion of the transmissive area into four quadrants, wherein angles of the slanted segments within the same quadrant are all the same.

12. The transflective LCD panel as claimed in claim 1, wherein each of the transparent pixel electrodes is substantially arrow-shaped within the corresponding transmissive area, and each of the transparent pixel electrodes respectively has a comb-shaped edge and a smooth edge within the transmissive area, wherein the smooth edges of the transparent pixel electrodes are disposed oppositely one another, wherein each of the pixel units includes a second alignment structure that has a comb-shaped opening of the common electrode layer, and indentations of the comb-shaped openings of the common electrode layer are interlaced with indentations of the comb-shaped edges of the transparent pixel electrodes.

13. The transflective LCD panel as claimed in claim 1, wherein each of the transmissive areas is divided into a first area located adjacent the reflective area and a second area away from the reflective area, each of the transparent pixel electrode has a comb-shaped edge and a smooth edge within the first area, and each of the transparent pixel electrode has a comb-shaped edge and a smooth edge within the second area, and the comb-shaped edges of each of the transparent pixel electrode within the first area and the second area are located at different sides of each of the transparent pixel electrodes.

14. The transflective LCD panel as claimed in claim 13, wherein the opposite substrate further has a common electrode layer and second alignment structures disposed in respective transmissive areas, wherein each of the second alignment structures is a comb-shaped opening of the common electrode layer.

15. The transflective LCD panel as claimed in claim 14, wherein indentations of the comb-shaped openings of the common electrode layer are interlaced with indentations of the comb-shaped edges of the transparent pixel electrodes.

16. The transfiective LCD panel as claimed in claim 14, wherein indentations of the comb-shaped openings of the common electrode layer are aligned with indentations of the comb-shaped edges of the transparent pixel electrodes.

17. The transflective LCD panel as claimed in claim 1, wherein shapes of any two adjacent transparent pixel electrode are symmetric.

18. A liquid crystal display (LCD) device, comprising:
a backlight module; and
a transflective LCD panel to receive light from the backlight module, comprising:
a first substrate having an array of pixel units, wherein each of the pixel units comprises:
an active device;
a transparent pixel electrode connected to the active device and disposed in a transmissive area of the corresponding pixel unit;
a reflective pixel electrode connected to the active device and disposed in a reflective area of the corresponding pixel unit, wherein the reflective pixel electrode has at least one first slit located adjacent a boundary between the transmissive area and the reflective area; and
an opposite substrate, spaced apart from the first substrate, and comprising:
a second substrate;
a plurality of cell-gap adjusting layers, respectively corresponding to the reflective pixel electrodes of the pixel units, wherein an edge of each cell-gap adjusting layer located near the boundary between the transmissive area and the reflective area is covered by a corresponding reflective pixel electrode..

19. The LCD device as claimed in claim 18, wherein in the opposite substrate further comprises:
a common electrode layer, covering the second substrate and the cell-gap adjusting layers;
a plurality of first alignment structures, disposed on the opposite substrate, and respectively corresponding to the reflective area of each of the pixel units; and
a plurality of second alignment structure, disposed on the opposite substrate, and respectively corresponding to the transmissive area of each of the pixel units; and
wherein the transfiective LCD panel further includes a liquid crystal layer, disposed between the active device array substrate and the opposite substrate.

20. The LCD device as claimed in the claim 18, wherein the first slit is located within an edge of a corresponding cell-gap adjusting layer.

21. A transflective LCD panel, comprising:
an active device array substrate, comprising a first substrate, a plurality of scan lines, a plurality of data lines and a plurality of pixel units, wherein the scan lines, the data lines and the pixel units are disposed on the first substrate, and each of the pixel units comprises:
an active device;
a transparent pixel electrode, disposed in a transmissive area of the pixel unit and electrically connected to the active device; and
a reflective pixel electrode, disposed in a reflective area of the pixel unit and electrically connected to the active device; and
an opposite substrate, spaced apart from the active device array substrate, and comprising:
a second substrate;
a plurality of cell-gap adjusting layers, respectively corresponding to the reflective pixel electrodes of the pixel units, wherein an edge of a cell-gap adjusting layer located near a boundary between the transmissive area and the reflective area of a corresponding pixel unit is covered by a corresponding reflective pixel electrode;
a common electrode layer, covering the second substrate and the cell-gap adjusting layers.

22. The transflective LCD panel as claimed in claim 21, wherein each reflective pixel electrode and cell-gap adjusting layer has a central opening surrounding the transparent pixel electrode.
